(19) United States
(12) Patent Application Publication
(10) Pub. No.: US 2026/0260831 A1
(43) Pub. Date: Sep. 3, 2026

(54) PROTECTING DEVICE AND METHOD FOR MANUFACTURING PROTECTING DEVICE

(71) Applicant: DEXERIALS CORPORATION, Tochigi (JP)

(72) Inventor: Chisato KOMORI, Tochigi (JP)

(73) Assignee: DEXERIALS CORPORATION, Tochigi (JP)

(21) Appl. No.: 18/877,828

(22) PCT Filed: Jun. 6, 2023
(86) PCT No.: PCT/JP2023/021020

§ 371 Date: Dec. 20, 2024

(30) Foreign Application Priority Data
Jun. 22, 2022 (JP) 2022-100560

(51) Int. Cl. H01H 37/00; H01H 9/00; H01H 11/06; H01H 37/34; H01H 37/76

(52) U.S. Cl. CPC H01H 37/002; H01H 9/0066; H01H 11/06; H01H 37/34; H01H 37/761

(57) ABSTRACT

Provided is a protecting device that can handle high currents while reducing the amount of the electrode formation material used to form electrodes and maintaining conductivity and connectivity. The protecting device includes an insulating substrate 2, a heat generator 3 provided on the insulating substrate 2, a first electrode 4 and a second electrode 5 provided on the insulating substrate 2, a heat-generator lead-out electrode 6 disposed between the first electrode 4 and the second electrode 5 and electrically connected to one end of the heat generator 3, and a meltable conductor 7 disposed on surfaces of the first electrode 4, the second electrode 5, and the heat-generator lead-out electrode 6 to provide an electrical connection between the first electrode 4 and the heat-generator lead-out electrode 6 and between the second electrode 5 and the heat-generator lead-out electrode 6, wherein the connection portions 8 of the first electrode 4, second electrode 5, and heat-generator lead-out electrode 6 connected to the meltable conductor 7 are formed thicker than the other portions.

### CROSS REFERENCE TO PRIOR APPLICATION

This application is a National Stage Patent Application of PCT International Patent Application No. PCT/JP2023/021020 (filed on Jun. 6, 2023) under 35 U.S.C. § 371, which claims priority to Japanese Patent Application No. 2022-100560 (filed on Jun. 22, 2022), which are all hereby incorporated by reference in their entirety.

### TECHNICAL FIELD

The present technology relates to a protecting device that is mounted on a current path and that, when a current exceeding the rated value flows, melts meltable conductor by heating with a heat generator to interrupt the current path.

### BACKGROUND ART

Lithium-ion secondary batteries (LiBs) are high power, high energy density batteries that are being used in a variety of applications as battery performance improves. However, LiBs have a risk of overheating and causing smoke and fire if they are overcharged due to a fault in the IC or FET that controls charging and discharging; therefore a protecting device with a heat generator is employed as a secondary protection measure. With the expansion of LiB-equipped applications, the production volume of LiBs is increasing and the demand for protecting devices to protect LiBs is growing.

As shown in FIGS. 12A to 12C, a protecting device 100 with a heat generator generally includes an insulating substrate 101, first and second electrodes 102, 103 formed on the front surface 101a of the insulating substrate 101 and connected to a protection circuit, a heat generator 105 formed on the back surface 101b of the insulating substrate 101 and electricity energized by an external signal to generate heat, a heat-generator lead-out electrode 106 that is electrically connected to the heat generator 105, and a meltable conductor 107 that is connected between the first and second electrodes 102, 103.

The first and second electrodes 102, 103 and the heat-generator lead-out electrode 106 are formed by applying and baking silver paste on the front surface 101a of the insulating substrate 101. As a result, each of the electrodes 102, 103, and 106 has the same thickness throughout. The meltable conductor 107 is connected to the first and second electrodes 102, 103 and the heat-generator lead-out electrode 106 using a connection material such as connecting solder.

### CITATION LIST

### Patent Literature

Patent Document 1: JP 2017-174592 A

### SUMMARY OF INVENTION

### Technical Problem

With the expansion of LiB-equipped applications in recent years, there is a growing demand for protecting devices that can handle higher currents at lower prices. Since silver paste is expensive, it is considered to reduce the amount of silver paste used to make the first and second electrodes and the heat-generator lead-out electrodes; however, if the electrode thickness is made thin (e.g. less than 10 μm), the glass component contained as a sintering and fixing component will precipitate on the electrode surface during baking, and there is a risk of impairing the conductivity with the meltable conductor and the connectivity with the insulating substrate and meltable conductor. In addition, reducing the thickness of the electrode also increases the resistance of the conductor, which can be a problem when handling high currents. Furthermore, if the electrode area is reduced in order to reduce the amount of silver paste used, the size of the meltable conductor also needs to be reduced, making it difficult to handle high currents.

An object of the present technology is to provide a protecting device and a manufacturing method for a protecting device that can handle high currents while reducing the amount of the electrode formation material used to form electrodes and maintaining conductivity and connectivity.

### Solution to Problem

In order to solve the above-described problems, a protecting device of the present technology includes: an insulating substrate; a heat generator provided on the insulating substrate; a first electrode and a second electrode provided on the insulating substrate; a heat-generator lead-out electrode disposed between the first electrode and the second electrode and electrically connected to one end of the heat generator; and a meltable conductor disposed on surfaces of the first electrode, the second electrode, and the heat-generator lead-out electrode to provide an electrical connection between the first electrode and the heat-generator lead-out electrode and between the second electrode and the heat-generator lead-out electrode, wherein the connection portions of the first electrode, the second electrode, and the heat-generator lead-out electrode connected to the meltable conductor are formed thicker than the other portions.

In order to solve the above-described problems, a protecting device of the present technology includes: an insulating substrate; a heat generator provided on the back surface of the insulating substrate; a first electrode and a second electrode provided on the insulating substrate; a meltable conductor disposed on surfaces of the first electrode and the second electrode to provide an electrical connection between the first electrode and the second electrode, wherein the connection portions of the first electrode and the second electrode connected to the meltable conductor are formed thicker than the other portions.

A method for manufacturing a protecting device of the present technology includes a step of forming a first electrode, a second electrode, and a heat-generator lead-out electrode disposed between the first electrode and the second electrode by printing and baking conductive paste on an insulating substrate; and a step of forming a connection electrode to be connected to a meltable conductor that connects the first electrode, the second electrode, and the heat-generator lead-out electrode by printing and baking conductive paste on the first electrode, the second electrode, and the heat-generator lead-out electrode, wherein the connection portions of the first electrode, the second electrode, and the heat-generator lead-out electrode to be connected to the meltable conductor are formed thicker than the other portions.

A method for manufacturing a protecting device of the present technology includes a step of forming a first electrode and a second electrode by printing and baking conductive paste on an insulating substrate; and a step of forming a connection electrode to be connected to a meltable conductor that connects the first electrode and the second electrode by printing and baking conductive paste on the first electrode and the second electrode, wherein the connection portions of the first electrode and the second electrode to be connected to the meltable conductor are formed thicker than the other portions.

### Advantageous Effects of Invention

The present technology reduces the amount of the electrode formation material used to form electrodes while maintaining conductivity and connectivity and is also capable of handling high currents.

### BRIEF DESCRIPTION OF DRAWINGS

FIGS. 1A-1C show a protecting device according to the present technology in which FIG. 1A is a plan view with the case omitted, FIG. 1B is a bottom view, and FIG. 1C is a cross-sectional view.

FIG. 2 is a plan view illustrating a state in which the meltable conductor has melted.

FIG. 3 is a cross-sectional view illustrating the connection portions of the first electrode.

FIG. 4 is a plan view illustrating a configuration in which the connection portions are formed slightly inward from the inner edge of the first electrode and second electrode.

FIG. 5 is a cross-sectional view of the meltable conductor.

FIG. 6 is a circuit diagram illustrating an example of a battery pack configuration.

FIG. 7 is a circuit diagram of a protecting device according to the present technology.

FIGS. 8A-8C show a protecting device according to a modification in which FIG. 8A is a plan view with the case omitted, FIG. 8B is a bottom view, and FIG. 8C is a cross-sectional view.

FIG. 9 is a plan view of a protecting device in the modification, with the case, the heat-generator lead-out electrode, and the meltable conductor omitted.

FIGS. 10A-10C show a protecting device according to another modification in which FIG. 10A is a plan view with the case omitted, FIG. 10B is a bottom view, and FIG. 10C is a cross-sectional view.

FIG. 11 is a figure showing a circuit configuration of a protecting device of another modification.

FIGS. 12A-12C show a protecting device with a heat generator, in which FIG. 12A is a plan view with the case omitted, FIG. 12B is a bottom view, and FIG. 12C is a cross-sectional view.

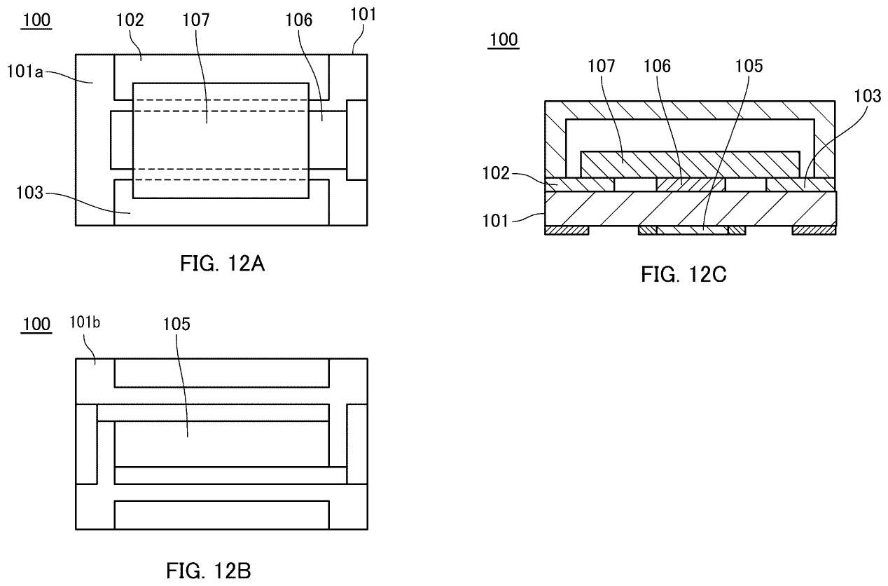

### DESCRIPTION OF EMBODIMENTS

Embodiments of a protecting device and a method for manufacturing a protecting device according to the present technology will now be more particularly described with reference to the accompanying drawings. It should be noted that the present technology is not limited to the embodiments described below and various modifications can be added to the embodiment without departing from the scope of the present technology. The features shown in the drawings are illustrated schematically and are not intended to be drawn to scale. Actual dimensions should be determined in consideration of the following description. Moreover, dimensional relations and proportions may be different among the drawings in some parts.

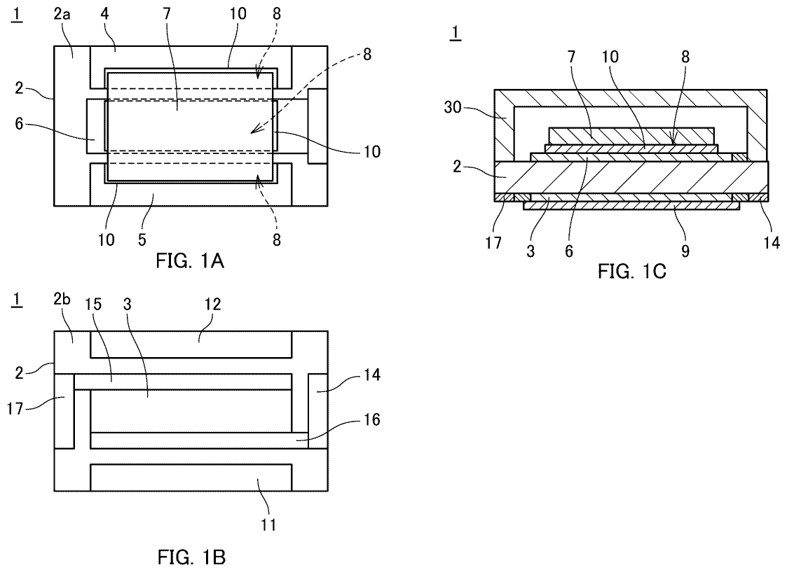

As shown in FIGS. 1A to 1C, the protecting device 1 according to the present technology includes an insulating substrate 2, a heat generator 3 provided on the insulating substrate 2, a first electrode 4 and a second electrode 5 provided on the insulating substrate 2, a heat-generator lead-out electrode 6 disposed between the first electrode 4 and the second electrode 5 and electrically connected to one end of the heat generator 3, and a meltable conductor 7 disposed on surfaces of the first electrode 4, second electrode 5 and heat-generator lead-out electrode 6 to provide an electrical connection between the first electrode 4 and heat-generator lead-out electrode 6 and between the second electrode 5 and heat-generator lead-out electrode 6. The protecting device 1 is formed so that the connection portions 8 of the first electrode 4, the second electrode 5, and the heat-generator lead-out electrode 6 to be connected to the meltable conductor 7 are formed thicker than the other portions.

The first electrode 4, the second electrode 5, and the heat-generator lead-out electrode 6 are formed such that the connection portions 8 to be connected to the meltable conductor 7 are formed thicker than the other portions, that is, the thickness of the parts other than the connection portions 8 can be made thinner such that the amount of the electrode formation material used to form the first electrode 4, second electrode 5 and heat-generator lead-out electrode 6 can be reduced compared to when the entire surface is formed with a uniform thickness.

In addition, the electrode formation material contains a glass component as a component for sintering and fixing to the insulating substrate 2, and if the electrode thickness is made extremely thin, there is a risk that the glass components will precipitate on the electrode surface, damaging the conductivity and connectivity with the meltable conductor 7; however, the protecting device 1 has a sufficient thickness at the connection portions 8 to which the meltable conductor 7 is connected, so that there is no precipitation of the glass component and it is possible to maintain the conductivity and the connection with the meltable conductor 7. Furthermore, the sufficient thickness of the connection portions 8 do not increase the conduction resistance. Therefore, the present technology can handle high currents while reducing the amount of the electrode formation material used to form electrodes and maintaining conductivity and connectivity.

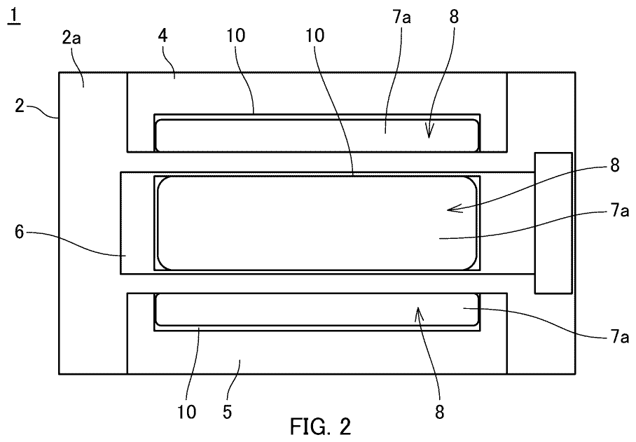

By incorporating the protecting device 1 having such a configuration into an external circuit, the meltable conductor 7 forms part of the current path of this external circuit to interrupt the current path by melting due to the heat generated by the heat generator 3 or due to an overcurrent exceeding the rated value (see FIG. 2). The following sections describe the details of each component of the protecting device 1.

### Insulating Substrate

The insulating substrate 2 is formed of an insulating material such as alumina, glass ceramics, mullite, or zirconia. Alternatively, the insulating substrate 2 may be made of other materials used for printed wiring boards, such as glass epoxy and phenolic substrates. In this specification, the surface of the insulating substrate 2 on which the meltable conductor 7 is mounted is referred to as the front surface 2a, and the surface opposite to the surface on which the meltable conductor 7 is mounted is referred to as the back surface 2b.

### First and Second Electrodes

On the front surface 2a of the insulating substrate 2 at the two ends opposing each other, the first electrode 4 and the second electrode 5 are formed. The first electrode 4 and the second electrode 5 are formed by a conductive pattern of Ag, Cu, or an alloy thereof. The first electrode 4 and the second electrode 5 can be formed by printing Ag paste in a predetermined pattern by screen printing and then baking at a predetermined temperature.

The first electrode 4 is connected to the first external connection electrode 11 formed on the back surface 2b of the insulating substrate 2 via castellation from the front surface 2a of the insulating substrate 2. The second electrode 5 is connected to the second external connection electrode 12 formed on the back surface 2b of the insulating substrate 2 via castellation from the front surface 2a of the insulating substrate 2. When the protecting device 1 is mounted on the external circuit board, the first and second external connection electrodes 11 and 12 are connected to the connection electrodes provided on the external circuit board, thereby incorporating the meltable conductor 7 into part of the current path formed on the external circuit board.

The first and second electrodes 4, 5 are electrically connected via the meltable conductor 7, by the meltable conductor 7 being mounted on the connection portions 8 via a conductive connection material such as connecting solder. As shown in FIG. 2, the first and second electrodes 4, 5 are disconnected by the heat generator 3 generating heat when energized, causing the meltable conductor 7 to melt, or by the protecting device 1 being subjected to a large current exceeding its rated current, causing the meltable conductor 7 to melt due to self-heating (Joule heat).

### Heat-Generator Lead-Out Electrode

The heat-generator lead-out electrode 6 is provided in the area between the first electrode 4 and the second electrode 5, and one end of the heat-generator lead-out electrode 6 is connected to the intermediate electrode 14 described below. In addition, the heat-generator lead-out electrode 6 is connected to the meltable conductor 7 via a connecting solder or other bonding material in the area between the first and second electrodes 4, 5.

### Connection Portion

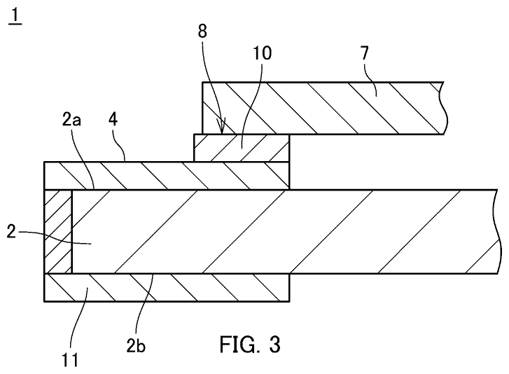

The connection portions 8 to be connected to the meltable conductor 7 are formed on the first electrode 4, the second electrode 5, and the heat-generator lead-out electrode 6. FIG. 3 is a cross-sectional view illustrating the connection portion 8 of the first electrode 4. As shown in FIGS. 1A, 1C, and 3, the connection portions 8 are formed by laminating connection electrodes 10 to a portion of the first and second electrodes 4, 5 to which the meltable conductor 7 is connected, e.g., portions along the inner edges of the first and second electrodes 4, 5 and in the center of the heat-generator lead-out electrode 6. The meltable conductor 7 is connected to the connection electrode 10 via a connection material such as solder.

It is preferable that the connection electrode 10 is formed from the same material as the first and second electrodes 4, 5 and the heat-generator lead-out electrode 6. For example, the connection electrode 10 is formed by printing a predetermined pattern of Ag paste using screen printing, and then baking the paste at a predetermined temperature so that the melted glass component contained in the Ag paste laminates and integrates the connection electrode 10 with the first and second electrodes 4, 5 and the heat-generator lead-out electrode 6 that were formed earlier. As a result, the connection portions 8 have sufficient thickness to maintain conductivity and connectivity with the meltable conductor 7 without any precipitation of the glass component.

In addition, the connection portions 8 are formed thicker than the other portions, and the connection electrodes 10 protrude above the first and second electrodes 4, 5 and the heat-generator lead-out electrode 6. This allows heat and pressure from the outside to be efficiently transmitted to the connection electrodes 10, which are portions to be connected with the meltable conductor 7. Therefore, when the meltable conductor 7 is mounted on the connection electrodes 10 by using, e.g., a soldering iron as well, heat and pressure can be efficiently applied to the connection electrodes 10 without spreading throughout the first and second electrodes 4, 5.

In addition, because the connection portions 8 are formed thicker than the other portions, when the meltable conductor 7 is mounted, the melted metal such as connecting solder that connects the meltable conductor 7 will be aggregated in the connection portions 8 and prevented from flowing out to the outer edge of the first and second electrodes 4, 5. Therefore, it is possible to prevent the melted connecting solder from wetly spreading to the first and second external connection electrodes 11 and 12 and to maintain the connection of the meltable conductor 7 and the connection between the protecting device 1 and the external circuit board.

As shown in FIG. 1A, the connection portions 8 preferably have an area approximately equal to that of the meltable conductor 7 on the first and second electrodes 4, 5. If the connection portions 8 are too small compared to the meltable conductor 7, there is a risk of an increase in the conduction resistance. On the other hand, if the connection portions 8 are too large compared to the meltable conductor 7, the effect of reducing the amount of electrode material used will deteriorate. For this reason, it is preferable to form the connection portions 8 so that when the meltable conductor 7 is arranged, the overlapping area ratio of the meltable conductor 7 to the connection portions 8 on the first and second electrodes 4, 5 is 90% to 110%.

The thickness of the connection portions 8, that is, the total thickness of the first electrode 4 and connection electrode 10, the total thickness of the second electrode 5 and connection electrode 10, and the total thickness of the heat-generator lead-out electrode 6 and connection electrode 10 are preferably 20 μm or more. This prevents the precipitation of glass components on the surface of the connection electrode 10 during the forming process of the connection electrode 10 and the mounting step of the meltable conductor 7 and ensures the conductivity and mechanical connection reliability of the meltable conductor 7.

In addition, the first and second electrodes 4, 5, and the heat-generator lead-out electrode 6, preferably have a thickness of 10 μm or more. This prevents the precipitation of the glass component not only in the connection portions 8 but also in areas other than the connection portions 8 and ensures the mechanical connection reliability with the insulating substrate 2.

The thickness of the connection portions 8 are preferably at least twice the thickness of the portions other than the connection portions 8 of the first and second electrodes 4, 5 and the heat-generator lead-out electrode 6. By increasing the number of printing processes for the connection portions 8 and making the thickness of the connection portions 8 thicker than the thickness of the other portions, the wettability of the bonding material such as the connecting solder used to connect the meltable conductor 7 can be improved. In addition, the printing and baking of the conductive paste forming the first and second electrodes 4, 5, the heat-generator lead-out electrode 6, and the connection electrode 10 can be repeated multiple times to achieve the desired thickness.

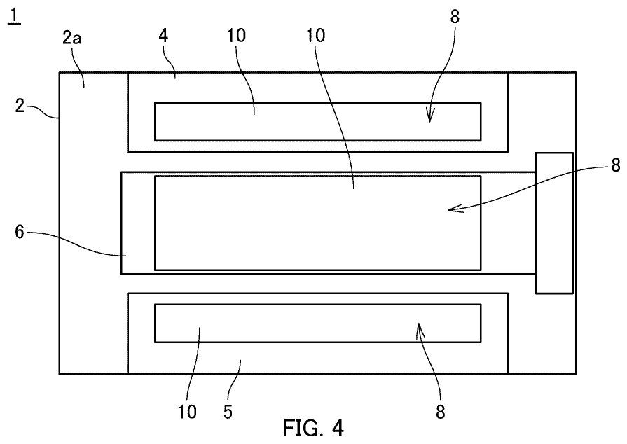

In addition, as shown in FIG. 4, the connection portions 8 may be formed slightly inward from the inner edge of the first electrode 4 and the second electrode 5. Since the connection portions 8 are formed thicker than the other portions and protrude upwardly, when the meltable conductor 7 is melted, positive tension toward the first and second electrodes 4, 5 sides is exerted on the melted conductor 7a to aggregate the melted conductor 7a on the connection portions 8 so that the connection between the first electrode 4 and the heat-generator lead-out electrode 6 and the connection between the second electrode 5 and the heat-generator lead-out electrode 6 can be interrupted more quickly. In this respect, forming the connection portions 8 slightly inside the inner edge of the first electrode 4 and the second electrode 5 can prevent the melted conductor 7a aggregated in each connection portions 8 after melting from coming into contact, thereby improving the insulation reliability.

It is preferable that a coating such as Ni/Au plating, Ni/Pd plating, or Ni/Pd/Au plating is applied to the surfaces of the first and second electrodes 4, 5 and the connection portions 8 using a known method such as plating. This allows the protecting device 1 to prevent the oxidation of the first and second electrodes 4, 5 and the connection portions 8 and to prevent fluctuations in ratings due to increased conduction resistance. In addition, when the protecting device 1 is reflow mounted, the coating will prevent the connection portions 8 from being eroded by the melted connecting solder (solder erosion) used to connect the meltable conductor 7.

In addition, the first and second electrodes 4, 5 may be provided with a regulatory wall to prevent the connecting solder provided on the electrodes of the external circuit board to be connected to the first and second external connection electrodes 11, 12 and melted during reflow mounting or the like from crawling up onto the first and second electrodes 4, 5 via the castellation and wetly spreading over the first and second electrodes 4, 5. The regulatory wall can be formed using an insulating material that does not have wettability for solder, such as glass, solder resist, or insulating adhesives, and can be formed on the first and second electrodes 4, 5 by printing or other means. The regulatory wall prevents the melted connecting solder from wetly spreading to the first and second electrodes 4, 5, thereby maintaining the connectivity between the protecting device 1 and the external circuit board.

### Heat Generator

As shown in FIG. 1B, the heat generator 3 is formed on the back surface 2b of the insulating substrate 2. The heat generator 3 is an electrically conductive member having a relatively high resistance value and generating heat when energized and is made of, e.g., nichrome, W, Mo, Ru, or a material containing these materials. The heat generator 3 can be formed by mixing the powder of these alloys, compositions, or compounds with a resin binder or the like to form a paste, forming a pattern on the insulating substrate 2 using screen printing technology, and then baking the paste. As an example, the heat generator 3 can be formed by preparing a mixture of ruthenium oxide paste and silver/glass paste according to a predetermined voltage, applying the mixture to form a film with a predetermined area at a predetermined position on the back surface 2b of the insulating substrate 2, and then baking the mixture under appropriate conditions. The shape of the heat generator 3 can be designed as desired, but as shown in FIG. 1B, it is preferable to make it substantially rectangular in shape according to the shape of the insulating substrate 2 in order to maximize the heating area.

The heat generator 3 is connected to a first lead-out electrode 15 at one end 3a and to a second lead-out electrode 16 at the other end 3b. The first lead-out electrode 15 leads out from a heat-generator electrode 17 along one end 3a of the heat generator 3, and in the protecting device 1 shown in FIG. 1B, extends along one side edge of the heat generator 3, which is formed into an approximately rectangular shape, and overlaps the one side edge of the heat generator 3. Similarly, the second lead-out electrode 16 leads out from the intermediate electrode 14 along the other end 3b of the heat generator 3, and in the protecting device 1 shown in FIG. 1B, extends along the other side edge of the heat generator 3, which is formed into an approximately rectangular shape, and overlaps the other side edge of the heat generator 3.

The heat-generator electrode 17 and the intermediate electrode 14 are formed on opposite side edges of the insulating substrate 2 different from the side edges provided with the first and second electrodes 4, 5. The heat-generator electrode 17, which is a power-feeding electrode for the heat generator 3, is connected to one end 3a of the heat generator 3 via the first lead-out electrode 15 and also functions as an external connection electrode when the protecting device 1 is connected to the external circuit.

The heat-generator electrode 17, the first and second lead-out electrodes 15 and 16, and the intermediate electrode 14 can be formed in the same way as the first and second electrodes 4, 5, by printing and baking a conductive paste such as Ag, Cu, or an alloy of these. In addition, by using the same material, each of these electrodes can be formed on the back surface 2b of the insulating substrate 2 in a single printing and baking step.

The intermediate electrode 14 is provided between the heat generator 3 and the heat-generator lead-out electrode 6 provided on the front surface 2a of the insulating substrate 2, and is connected to the other end 3b of the heat generator 3, and is connected to the heat-generator lead-out electrode 6 formed on the front surface 2a of the insulating substrate 2 via castellation. The heat-generator lead-out electrode 6 overlaps the heat generator 3 via the insulating substrate 2 and is also connected to the meltable conductor 7.

### Insulating Protective Layer

The heat generator 3, the first lead-out electrode 15, and the second lead-out electrode 16 may also be covered with an insulating protective layer 9. The insulating protective layer 9 is provided to protect and insulate the heat generator 3 and is made of an insulating material such as glass that has heat resistance to the heating temperature of the heat generator 3. Examples of glass materials that can be used to make the insulating material 9 include silica glass overcoat glass paste and insulating glass paste.

The insulating protective layer 9 can be formed by applying the glass paste using screen printing or other methods and baking the paste. In the protecting device 1 shown in FIG. 1C, the insulating protective layer 9 is formed to cover the heat generator 3, the first lead-out electrode 15, and the second lead-out electrode 16 formed on the back surface 2b of the insulating substrate 2.

The thickness of the insulating protective layer 9 is set from the perspective of the coating properties of the glass paste or the like and the interruption time of the meltable conductor 7. In other words, the thickness of the insulating protective layer 9 is set appropriately in accordance with the coating properties of the glass paste or the like and the required interruption time of the meltable conductor 7 and is set to be, e.g., 10 μm or more and 40 μm or less, and preferably 20 μm or more and 40 μm or less.

### Meltable Conductor

Next, the meltable conductor 7 will be explained. The meltable conductor 7 is mounted between the first and second electrodes 4, 5, and melts due to heat generation caused by the heat generator 3 being energized or self-heating (Joule heat) caused by the current exceeding its rated value flowing therethrough, thereby interrupting the current path between the first electrode 4 and the second electrode 5. The meltable conductor 7 is connected to the first and second electrodes 4, 5 and the heat-generator lead-out electrode 6 via a bonding material such as connecting solder.

The meltable conductor 7 can be any conductive material that melts due to the heat generated by the energized heat generator 3 or due to an overcurrent condition, and for example, may be made of SnAgCu-based Pb-free solder as well as BiPbSn alloy, BiPb alloy, BiSn alloy, SnPb alloy, PbIn alloy, ZnAl alloy, InSn alloy, and PbAgSn alloys, among other materials.

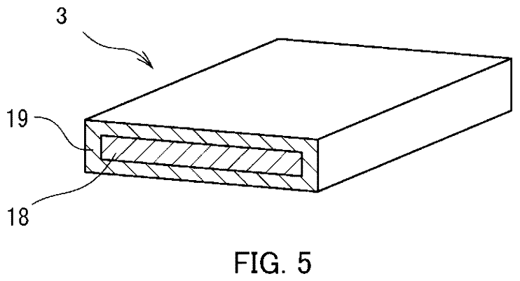

In addition, the meltable conductor 7 may be a structure having a high-melting-point metal and a low-melting-point metal. For example, as shown in FIG. 5, the meltable conductor 7 may have a laminated structure comprising an inner layer and an outer layer and may include a low-melting-point metal layer 18 as the inner layer and a high-melting-point metal layer 19 as the outer layer laminated to the low-melting-point metal layer 18.

The low-melting-point metal layer 18 is preferably a solder or Sn-based metal and is commonly referred to as “Pb-free solder”. The melting point of the low-melting-point metal layer 18 does not necessarily need to be higher than the reflow temperature and may melt at about 200° C. The high-melting-point metal layer 19 is a metal layer laminated on the surface of the low-melting-point metal layer 18, made of, e.g., Ag or Cu, or a metal mainly composed of one of these, and has a high melting point that does not melt even when reflow process is performed to connect the first and second electrodes 4, 5 and the heat-generator lead-out electrode 6 to the meltable conductor 7 and to mount the protecting device 1 on the external circuit board.

Such a meltable conductor 7 can be formed by depositing a high-melting-point metal layer on a low-melting-point metal foil using plating technology, or by using other well-known laminating or film-forming technologies. In addition, the meltable conductor 7 may have a structure in which the entire surface of the low-melting-point metal layer 18 is covered by the high-melting-point metal layer 19 or may have a structure in which it is covered except for a pair of opposing sides. Furthermore, the meltable conductor 7 can be formed in various configurations, such as having the high-melting-point metal layer 19 as the inner layer and the low-melting-point metal layer 18 as the outer layer, having a multilayer structure of three or more layers in which the low-melting-point metal layer 18 and the high-melting-point metal layer 19 are alternately laminated, or having an opening in part of the outer layer to expose part of the inner layer.

By laminating the high-melting-point metal layer 19 as the outer layer on the low-melting-point metal layer 18 as the inner layer, the meltable conductor 7 can maintain the shape as the meltable conductor 7 and will not be blown even when the reflow temperature exceeds the melting temperature of the low-melting-point metal layer 18. Therefore, the first and second electrodes 4, 5 and the heat-generator lead-out electrode 6 can be connected to the meltable conductor 7, and the protecting device 1 is mounted on the external circuit board efficiently by reflow, and it is possible to prevent changes in blowout properties, which might otherwise cause a problem in which the meltable conductor 7 might be deformed to locally increase or decrease the resistance value so that it cannot be blown at a predetermined temperature or will be blown below a predetermined temperature.

In addition, the meltable conductor 7 does not melt due to self-heating as long as the predetermined rated current flows. When a current exceeding the rated value flows, the meltable conductor 7 melts due to self-heating and interrupts the current path between the first and second electrodes 4, 5. In addition, when the heat generator 3 is energized and generates heat, the meltable conductor 7 is blown to interrupt the current path between the first and second electrodes 4, 5.

At this time, in the meltable conductor 7, the melted low-melting-point metal layer 18 erodes the high-melting-point metal layer 19 (solder erosion), whereby the high-melting-point metal layer 19 melts at a temperature lower than the melting temperature thereof. Therefore, the meltable conductor 7 can be blown in a short time by utilizing the erosion action on the high-melting-point metal layer 19 by the low-melting-point metal layer 18. In addition, since the melted conductor 7a of the meltable conductor 7 is separated by the physical drawing action of the connection portions 8 provided on the heat-generator lead-out electrode 6 and the first and second electrodes 4, 5, the current path between the first and second electrodes 4, 5 can be quickly and reliably interrupted (FIG. 2).

The meltable conductor 7 may be made so that the volume of the low-melting-point metal layer 18 is larger than that of the high-melting-point metal layer 19. The meltable conductor 7 is heated by self-heating due to an overcurrent or by heat generation by the heat generator 3, and the low-melting-point metal melts and erodes the high-melting-point metal, which can quickly melt and blow the meltable conductor 7. Therefore, by forming the volume of the low-melting-point metal layer 18 larger than that of the high-melting-point metal layer 19, the meltable conductor 7 can promote this corrosion action and quickly interrupt the path between the first and second electrodes 4, 5.

Further, the meltable conductor 7, which is composed of the high-melting-point metal layer 19 laminated on the low-melting-point metal layer 18 serving as the inner layer, can significantly reduce the melting temperature compared to conventional chip fuses and other fuses made of high-melting-point metal. Therefore, the meltable conductor 7 can be formed to have a larger cross-sectional area and a much higher current rating compared to chip fuses of the same size. In addition, the meltable conductor 7 can be made smaller and thinner than conventional chip fuses having the same current rating and is excellent in the rapid blowout property.

In addition, the meltable conductor 7 can improve resistance to a surge (pulse resistance) which would occur when an abnormally high voltage is momentarily applied to the electric system incorporating the protecting device 1. For example, the meltable conductor 7 must not be blown in the case of a 100 A current flowing for a few milliseconds. In this respect, since a large current flowing for an extremely short time flows through the surface layer of the conductor (skin effect), and the meltable conductor 7 is provided with the high-melting-point metal layer 19 such as Ag plating with low resistance as an outer layer, a current caused by a surge can easily flow to prevent blowout due to self-heating. Therefore, the meltable conductor 7 can significantly improve serge tolerance compared to fuses made of conventional solder alloys.

The meltable conductor 7 may be coated with flux (not shown) to prevent oxidation and to improve wettability at the time of blowout. In the protecting device 1, the insulating substrate 2 is protected by being covered by the case 30. The case 30 can be formed from an insulating material such as various engineering plastics, thermoplastics, ceramics, and glass epoxy substrates, among others. The case 30 has a sufficient internal space on the front surface 2a of the insulating substrate 2 for the melted meltable conductor 7 to expand spherically when melted and for the melted conductor 7a to agglomerate on the heat-generator lead-out electrode 6 and the first and second electrodes 4, 5.

### Circuit Configuration Example

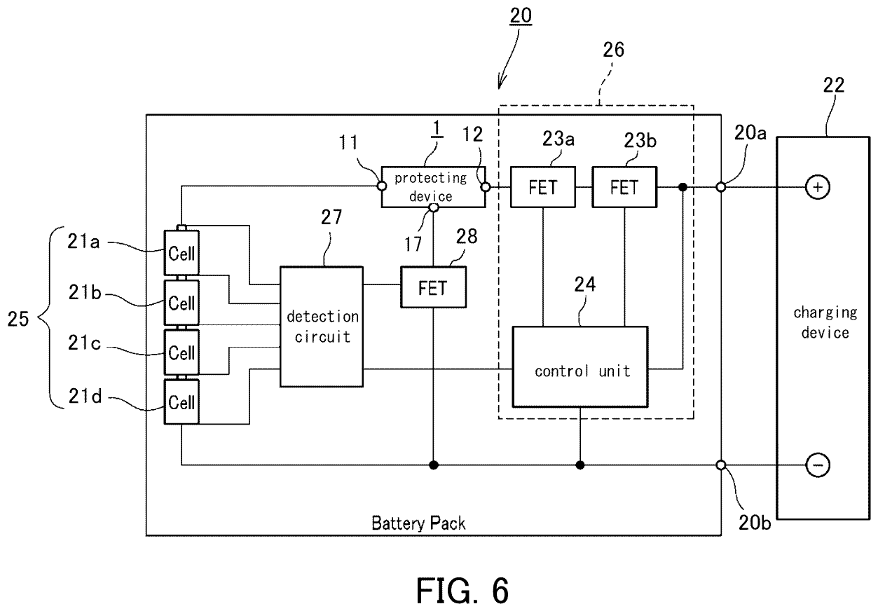

The protecting device 1 is used, e.g., in the circuit in a battery pack 20 of a lithium-ion secondary battery. The battery pack 20 includes a battery stack 25 having a plurality of, e.g., a total of four lithium-ion secondary battery cells 21a to 21d, as shown in FIG. 6.

The battery pack 20 includes a battery stack 25, a charge/discharge control circuit 26 that controls the charge/discharge of the battery stack 25, the protecting device 1 according to the present invention that interrupts a charging/discharging path when the state of the battery stack 25 is abnormal, a detection circuit 27 that detects the voltage of each battery cell 21a to 21d, and a current control element 28 that serves as a switch element to control the operation of the protecting device 1 in accordance with the detection results of the detection circuit 27.

In the battery stack 25, the battery cells 21a to 21d requiring control for protection from over-charging and over-discharging states are connected in series and are detachably connected to the charging device 22 via a positive electrode terminal 20a and a negative electrode terminal 20b of the battery pack 20, so as to apply charging voltage from the charging device 22. By connecting the positive electrode terminal 20a and the negative electrode terminal 20b to a battery-driven electronic device, the battery pack 20 charged by the charging device 22 can drive the electronic device.

The charge/discharge control circuit 26 includes two current control elements 23a, 23b connected in series in the current path between the battery stack 25 and the charging device 22, and a control unit 24 for controlling operations of the current control elements 23a, 23b. The current control elements 23a, 23b are formed of, for example, field effect transistors (hereinafter referred to as FETs) and the control unit 24 controls the gate voltage to switch the current path of the battery stack 25 between a conducting state and an interrupted state in the charging and/or discharging direction. The control unit 24 is powered by the charging device 22 and controls the operation of the current control elements 23a, 23b in accordance with the detection result by the detection circuit 27 to interrupt the current path when over-discharging or over-charging occurs in the battery stack 25.

The protecting device 1 is connected in a charge/discharge current path between the battery stack 25 and the charge/discharge control circuit 26, for example, and the operation thereof is controlled by the current control element 28.

The detection circuit 27 is connected to each of the battery cells 21a to 21d so as to detect the voltage values of each of the battery cells 21a to 21d and supplies each of the voltage values to the control unit 24 of the charge/discharge control circuit 26. Furthermore, when an over-charging voltage or an over-discharging voltage is detected in any one of the battery cells 21a to 21d, the detection circuit 27 outputs a control signal for controlling the current control element 28.

When the detection signal output from the detection circuit 27 indicates a voltage exceeding a predetermined threshold value corresponding to over-discharging or over-charging state of the battery cells 21a to 21d, the current control element 28 such as an FET, for example, activates the protecting device 1 to interrupt the charging/discharging current path of the battery stack 25 without the switching operation of the current control elements 23a, 23b.

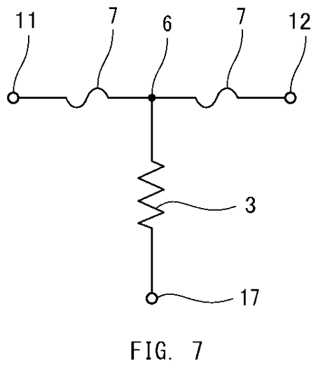

The protecting device 1 according to the present technology, which is used in the battery pack 20 having the above-described configuration, has a circuit configuration as shown in FIG. 7. That is, in the protecting device 1, the first external connection electrode 11 is connected to the battery stack 25 side, and the second external connection electrode 12 is connected to the positive electrode terminal 20a side, whereby the meltable conductor 7 is connected in series in the charging/discharging path of the battery stack 25. Furthermore, in the protecting device 1, the heat generator 3 is connected to the current control element 28 via the heat-generator electrode 17, and the heat generator 3 is also connected to the battery stack 25. In this way, one end of the heat generator 3 is connected to the meltable conductor 7 and one end of the battery stack 25 via the heat-generator lead-out electrode 6, and the other end of the heat generator 3 is connected to the current control element 28 and the other end of the battery stack 25 via the heat-generator electrode 17. This forms a power supply path to the heat generator 3 the conduction of which is controlled by the current control element 28.

### Operation of Protecting Device

Upon detecting an abnormal voltage in any of the battery cells 21a to 21d, the detection circuit 27 outputs an interruption signal to the current control element 28. The current control element 28 then controls the current so as to energize the heat generator 3. In the protecting device 1, a current flows from the battery stack 25 to the heat generator 3, and this causes the heat generator 3 to start generating heat. The protecting device 1 causes the meltable conductor 7 to melt due to the heat generated by the heat generator 3 to interrupt the charging/discharging path of the battery stack 25. In the protecting device 1, by forming the meltable conductor 7 with a high-melting-point metal and a low-melting-point metal, the low-melting-point metal is melted before the melting of the high-melting-point metal, and the meltable conductor 7 can be blown in a short time by utilizing the erosive action on the high-melting-point metal by the melted low-melting-point metal.

The melted conductor 7a of the meltable conductor 7 aggregate on the connection portions 8 formed on the first electrode 4, the second electrode 5, and the heat-generator lead-out electrode 6, thereby interrupting the current path between each electrode. Since the connection electrode 10 of the connection portions 8 protrudes from the other portions, positive tension toward the first and second electrodes 4, 5 sides is exerted on the melted conductor 7a to aggregate the melted conductor 7a on the connection portions 8 so that the connection between the first electrode 4 and the heat-generator lead-out electrode 6 and the connection between the second electrode 5 and the heat-generator lead-out electrode 6 can be interrupted more quickly. In addition, the ability to quickly melt the meltable conductor 7 also prevents the heat generator 3 from being damaged before the meltable conductor 7 melts, allowing the current path to be safely and quickly interrupted.

The protecting device 1 stops the heating of the heat generator 3 by blowing the meltable conductor 7 to interrupt the power supply path to the heat generator 3.

In addition, when a rate-exceeding overcurrent flows through the battery pack 20, the protecting device 1 can blow the meltable conductor 7 by self-heating to interrupt the charging/discharging path of the battery pack 20.

As described above, in the protecting device 1, the meltable conductor 7 is blown by heat generated in the heat generator 3 or the self-heat generation of the meltable conductor 7 at the time of overcurrent. As mentioned above, since the protecting device 1 has a structure in which a low-melting-point metal is coated with a high-melting-point metal, the protecting device 1 can suppress deformation of the meltable conductor 7 even when the protecting device 1 is mounted on a circuit board by reflow mounting or the circuit board on which the protecting device 1 is mounted is exposed to a high-temperature environment such as reflow heating. Therefore, it is possible to prevent changes in blowout properties caused by changes in resistance values or the like due to deformation of the meltable conductor 7 and to quickly blow the meltable conductor 7 by the predetermined overcurrent or the heat generation of the heat generator 3.

The protecting device 1 according to the present technology is not limited to the cases where it is used for a battery pack of a lithium-ion secondary battery and is of course applicable to various applications requiring interruption of a current path by an electric signal.

### Modification 1

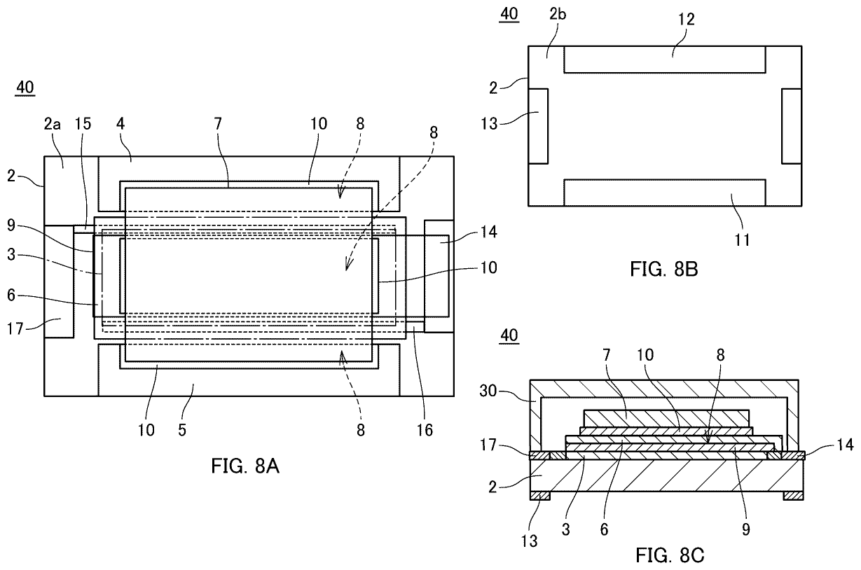

Next, a modification of the protecting device according to the present technology is described. In the following description, the same parts and materials as those of the above-described protecting device 1 are indicated with the same symbols and their details may be omitted. The protecting device 40 shown in FIGS. 8A to 8C is formed by forming the heat generator 3, the first lead-out electrode 15, the second lead-out electrode 16, the heat-generator electrode 17, and the insulating protective layer 9 on the front surface 2a of the insulating substrate 2, and the other configurations are the same as the protecting device 1 described above.

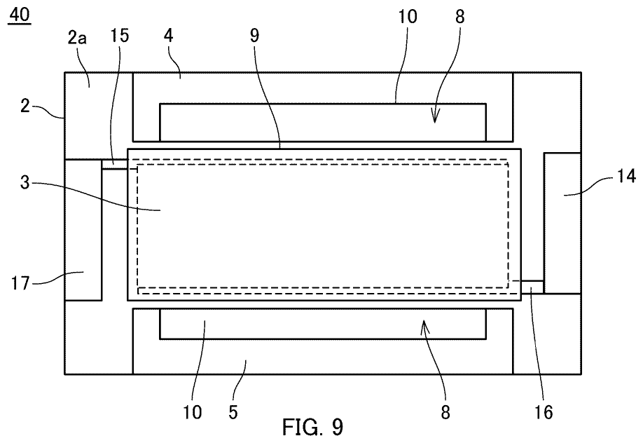

FIG. 9 is a plan view of the protecting device 40, in which the case 30, the heat-generator lead-out electrode 6, and the meltable conductor 7 are omitted. The heat-generator electrode 17 and the intermediate electrode 14 are formed on opposite side edges of the front surface 2a of the insulating substrate 2 different from the side edges provided with the first and second electrodes 4, 5. The heat-generator electrode 17 is connected to a third external connection electrode 13, which is formed on the back surface 2b of the insulating substrate 2, via castellation. The third external connection electrode 13 is connected to the current control element 28 by mounting the protecting device 40 on the external circuit.

In addition, as with the first and second electrodes 4, 5, the heat-generator electrode 17 may be provided with a regulatory wall to prevent the connecting solder provided on the electrode of the external circuit board to be connected to the third external connection electrode 13 and melted during reflow mounting or the like from crawling up onto the heat-generator electrode 17 via the castellation and wetly spreading over the heat-generator electrode 17.

The heat generator 3, the first lead-out electrode 15, and the second lead-out electrode 16 are formed in the area between the first electrode 4 and the second electrode 5 and are covered with the insulating protective layer 9. In addition, the heat-generator lead-out electrode 6 is connected at one end to the intermediate electrode 14, is formed on the insulating protective layer 9, and thus overlaps the heat generator 3 via the insulating protective layer 9.

Since the heat generator 3 of the protecting device 40 is formed on the same front surface 2a of the insulating substrate 2 as the meltable conductor 7, the heat of the heat generator 3 is easily transferred to the meltable conductor 7.

### Modification 2

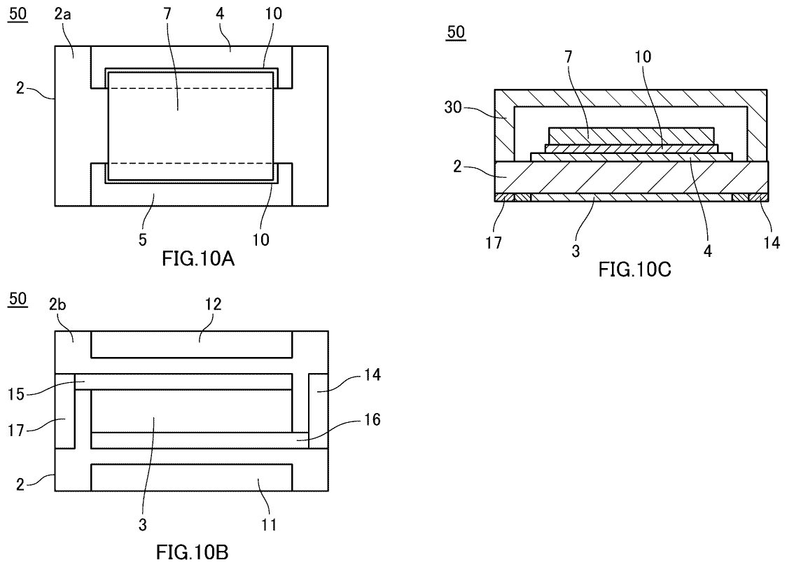

Next, another modification of the protecting device according to the present technology is described. In the following explanation, the same parts and materials as those of the above-described protecting devices 1, 40 are indicated with the same symbols and their details may be omitted. As shown in FIGS. 10A to 10C, the protecting device 50 according to the present technology omits the heat-generator lead-out electrode 6 and separates the current path of the meltable conductor 7 from the current path of the heat generator 3. The heat generator 3 formed on the back surface 2b of the insulating substrate 2 is connected to the heat-generator electrode 17 via the first lead-out electrode 15 at one end and is connected to the intermediate electrode 14 via the second lead-out electrode 16 at the other end.

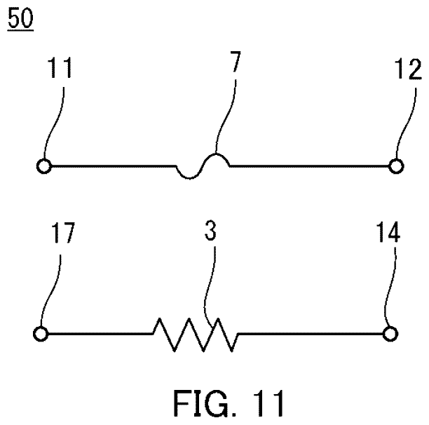

FIG. 11 shows the circuit configuration of the protecting device 50. When the protecting device 50 is mounted on the external circuit, the first external connection electrode 11 is connected to the battery stack 25 side, and the second external connection electrode 12 is connected to the positive electrode terminal 20a side, whereby the meltable conductor 7 is connected in series on the charging/discharging path of the battery stack 25. The heat generator 3 is connected to the current control element 28 via the heat-generator electrode 17 and is also connected to the battery stack 25. In addition, the heat generator 3 is connected to the ground (not shown) via the intermediate electrode 14. This forms a power supply path to the heat generator 3 the conduction of which is controlled by the current control element 28. In the protecting device 50, when the meltable conductor 7 melts, the detection circuit 27 and the current control element 28 detect this and stop the power supply to the heat generator 3.

### REFERENCE SIGNS LIST

1 protecting device, 2 insulating substrate, 3 heat generator, 4 first electrode, 5 second electrode, 6 heat-generator lead-out electrode, 7 meltable conductor, 8 connection portion, 9 insulating protective layer, 10 connection electrode, 11 first external connection electrode, 12 second external connection electrode, 13 third external connection electrode, 14 intermediate electrode, 15 first lead-out electrode, 16 second lead-out electrode, 17 heat-generator electrode, 18 low-melting-point metal layer, 19 high-melting-point metal layer, 20 battery pack, 21 battery cell, 22 charging device, 23 current control element, 24 control unit, 25 battery stack, 26 charge/discharge control circuit, 27 detection circuit, 28 current control element, 30 case, 40 protecting device, 50 protecting device

1. A protecting device, comprising:
an insulating substrate;
a heat generator provided on the insulating substrate;
a first electrode and a second electrode provided on the insulating substrate;
a heat-generator lead-out electrode disposed between the first electrode and the second electrode and electrically connected to one end of the heat generator; and
a meltable conductor disposed on surfaces of the first electrode, the second electrode, and the heat-generator lead-out electrode to provide an electrical connection between the first electrode and the heat-generator lead-out electrode and between the second electrode and the heat-generator lead-out electrode, wherein
the connection portions of the first electrode, the second electrode, and the heat-generator lead-out electrode connected to the meltable conductor are formed thicker than the other portions.

2. The protecting device according to claim 1, wherein the connection portions comprise portions on which the respective meltable conductors of the first electrode, the second electrode, and the heat-generator lead-out electrode are mounted and connection electrodes laminated to each of the portions.

3. The protecting device according to claim 2, wherein the connection electrode is composed of the same components as that of the first electrode, the second electrode, or the heat-generator lead-out electrode, which are laminated respectively.

4. The protecting device according to claim 1, wherein the connection portions have a thickness of 20 μm or more.

5. The protecting device according to claim 4, wherein the first electrode, the second electrode, and the heat-generator lead-out electrode have a thickness of 10 μm or more.

6. The protecting device according to claim 1, wherein the thickness of the connection portions is at least twice the thickness of the other portions other than the connection portions of the first electrode, the second electrode, or the heat-generator lead-out electrode, which are laminated respectively.

7. The protecting device according to claim 1, wherein the heat generator is formed on the back surface of the insulating substrate, opposite to the front surface on which the meltable conductor is formed.

8. The protecting device according to claim 1, wherein
the heat generator is formed on the front surface of the insulating substrate on which the meltable conductor is provided,
the heat generator is covered with a insulating protective layer, and
the heat-generator lead-out electrode is provided on the insulating protective layer.

9. The protecting device according to claim 1, wherein the insulating substrate is a ceramic substrate.

10. A protecting device, comprising:
an insulating substrate;
a heat generator provided on the back surface of the insulating substrate;
a first electrode and a second electrode provided on the insulating substrate;
a meltable conductor disposed on surfaces of the first electrode and the second electrode to provide an electrical connection between the first electrode and the second electrode, wherein
the connection portions of the first electrode and the second electrode connected to the meltable conductor are formed thicker than the other portions.

11. The protecting device according to claim 10, wherein the connection portions comprise portions on which the respective meltable conductors of the first electrode and the second electrode are mounted and connection electrodes laminated to each of the portions.

12. A method for manufacturing a protecting device, comprising:
a step of forming a first electrode, a second electrode, and a heat-generator lead-out electrode disposed between the first electrode and the second electrode by printing and baking conductive paste on an insulating substrate; and
a step of forming a connection electrode to be connected to a meltable conductor that connects the first electrode, the second electrode, and the heat-generator lead-out electrode by printing and baking conductive paste on the first electrode, the second electrode, and the heat-generator lead-out electrode, wherein
the connection portions of the first electrode, the second electrode, and the heat-generator lead-out electrode to be connected to the meltable conductor are formed thicker than the other portions.

13. A method for manufacturing a protecting device, comprising:
a step of forming a first electrode and a second electrode by printing and baking conductive paste on an insulating substrate; and
a step of forming a connection electrode to be connected to a meltable conductor that connects the first electrode and the second electrode by printing and baking conductive paste on the first electrode and the second electrode, wherein
the connection portions of the first electrode and the second electrode to be connected to the meltable conductor are formed thicker than the other portions.
